(19) United States
(12) Patent Application Publication
(10) Pub. No.: US 2015/0337913 A1
(43) Pub. Date: Nov. 26, 2015

(54) ENGAGING/DISENGAGING MECHANISM

(71) Applicant: Koji TAKAIRA, Okazaki-shi (JP)

(72) Inventor: Koji TAKAIRA, Okazaki-shi (JP)

(73) Assignee: TOYOTA JIDOSHA KABUSHIKI KAISHA, Toyota-shi (JP)

(21) Appl. No.: 14/652,561

(22) PCT Filed: Jan. 25, 2013
(86) PCT No.: PCT/JP2013/051592

§ 371 Date: Jun. 16, 2015

(51) Int. Cl. F16D 48/06; F16D 27/118

(52) U.S. Cl. CPC F16D 48/064; F16D 27/118

(57) ABSTRACT

An engaging/disengaging mechanism including: an actuation mechanism capable of transmitting power to an engaging member to move the engaging member in a first direction to switch the engaging/disengaging mechanism into an engaged state and in a second direction to switch the engaging/disengaging mechanism into a disengaged state; and an elastic member capable of storing such elastic force that the engaging member is moved in the second direction to switch the engaging/disengaging mechanism into the disengaged state, wherein to switch the engaging/disengaging mechanism into the engaged state, the power transmitted by the actuation mechanism is reduced after the engaging member is moved by the power transmitted by the actuation mechanism so that the engaging/disengaging mechanism is switched into the engaged state, the elastic force of the elastic member being less intense when the engaging member is in the position than when the engaging/disengaging mechanism is switched into the disengaged state.

### TECHNICAL FIELD

The present invention relates to an engaging/disengaging mechanism that, provided in a power transmission system for a vehicle or other like machinery, switches between an engaged state where power can be transmitted and a disengaged state where power cannot be transmitted.

### BACKGROUND ART

Vehicles or other like machinery include an engaging/disengaging mechanism in their power transmission systems to selectively switch between power transmission and no power transmission. A well-known example of such an engaging/disengaging mechanism is the electromagnetic clutch. An electromagnetic clutch is structured, for example, to move an armature against the elastic force of an elastic member (clutch disengaging spring) by magnetic force generated by an electromagnetic coil when the electromagnetic coil is supplied with electric power, in order to switch the clutch (engaging/disengaging mechanism) to an engaged state (see, for example, Patent Documents 1 and 2).

### CITATION LIST

### Patent Literature

Patent Document 1: Japanese Patent Application Publication, Tokukaihei, No. 11-159545.
Patent Document 2: Japanese Patent Application Publication, Tokukai, No. 2003-278800.

### SUMMARY OF THE INVENTION

### Problems to be Solved by the Invention

In the electromagnetic clutch (engaging/disengaging mechanism) described in Patent Documents 1 and 2, the magnetism coil needs to be always supplied with electric power during the engaged state in order to generate a magnetic force that is sufficiently intense to overcome the elastic force (repulsive force) of the elastic member (sufficiently intense to maintain the armature in the engaged position). This arrangement inevitably adds to power consumption.

The present invention, conceived in view of this problem, has an object to provide an engaging/disengaging mechanism capable of reducing energy consumption during the engaged state.

### Solution to Problem

The present invention is an engaging/disengaging mechanism that enables/disables power transmission including: an actuation mechanism capable of transmitting power to an engaging member in order to move the engaging member in a first direction to switch the engaging/disengaging mechanism into an engaged state and in a second direction to switch the engaging/disengaging mechanism into a disengaged state; and an elastic member capable, as a result of the engaging member being moved in the first direction, of storing such elastic force that the engaging member is moved in the second direction to switch the engaging/disengaging mechanism into the disengaged state, wherein to switch the engaging/disengaging mechanism into the engaged state, the power transmitted by the actuation mechanism to the engaging member is reduced after the engaging member is moved in the first direction to a position by the power transmitted by the actuation mechanism to the engaging member so that the engaging/disengaging mechanism is switched into the engaged state, the elastic force of the elastic member being less intense when the engaging member is in the position than when the engaging/disengaging mechanism is switched into the disengaged state.

According to the present invention, to switch the engaging/disengaging mechanism into the engaged state, the engaging member (sleeve) is moved to a position (e.g., the position of stroke x1 shown in FIG. 6(A)) at which the engaging member has a less intense elastic force than when the engaging/disengaging mechanism is switched into the disengaged state. After that, the power transmitted by the actuation mechanism is reduced. This arrangement eliminates the need for the power transmitted by the actuation mechanism to the engaging member to overcome the repulsive force of the elastic member while the engaging/disengaging mechanism is in the engaged state. The present invention is therefore capable of maintaining the engaging/disengaging mechanism in the engaged state while allowing for reduction in energy consumption.

In the present invention, to switch the engaging/disengaging mechanism into the disengaged state, the power transmitted by the actuation mechanism may be reduced after the engaging member is moved in the first direction to another position by the power transmitted by the actuation mechanism to the engaging member, the elastic force of the elastic member being such that the engaging/disengaging mechanism is switched into the disengaged state when the engaging member is in the other position.

The power transmitted by the actuation mechanism to the engaging member is reduced after the engaging member (sleeve) is moved to the other position (e.g., the position of stroke x2 shown in FIG. 6(B)), the elastic force stored in the elastic member being capable of disengaging the engaging/disengaging mechanism when the engaging member is in the other position. This reduction of the power allows for reduction of energy consumption while the engaging/disengaging mechanism is in the disengaged state.

A specific arrangement example of the present invention is such that: the actuation mechanism includes: an armature provided integrally to the engaging member; and an electromagnetic coil; and the actuation mechanism magnetically attracts the armature by supplying electricity to the electromagnetic coil in order to move the engaging member in the first direction.

In this arrangement, to switch the engaging/disengaging mechanism into the engaged state or to maintain the engaging/disengaging mechanism in the engaged state, the electromagnetic coil may be supplied with less electricity than to switch the engaging/disengaging mechanism into the disengaged state. This arrangement allows for reduction of electric power consumption when the engaging/disengaging mechanism is switched into the engaged state. The arrangement also allows for reduction of electric supply to the electromagnetic coil while maintaining the engaging/disengaging mechanism in the engaged state. The present invention is therefore capable of reduction of electric power consumption and reduction of heat generation by the electromagnetic coil.

In the engaging/disengaging mechanism arranged to include the electromagnetic coil, to maintain the engaging/disengaging mechanism in the engaged state, the electromagnetic coil may be stopped from being supplied with electricity. This arrangement allows for more effective reduction of electric power consumption while the engaging/disengaging mechanism is in the engaged state.

In addition, to maintain the engaging/disengaging mechanism in the engaged state, the electromagnetic coil may be supplied with electricity that is less than to switch the engaging/disengaging mechanism into the engaged state, but sufficient to maintain the engaging/disengaging mechanism in the engaged state. This arrangement enables the engaging/disengaging mechanism to be reliably maintained in the engaged state even if the engaging/disengaging mechanism is subject to vibration or like disturbance.

In the engaging/disengaging mechanism arranged to include the electromagnetic coil, to switch the engaging/disengaging mechanism into the disengaged state, the electromagnetic coil may be stopped from being supplied with electricity after the engaging member is moved in the first direction to a further position by supplying electricity to the electromagnetic coil, the elastic force of the elastic member being such that the engaging/disengaging mechanism is switched into the disengaged state when the engaging member is in the further position. This arrangement allows for more effective reduction of electric power consumption while the engaging/disengaging mechanism is in the disengaged state.

In addition, to switch the engaging/disengaging mechanism into the disengaged state, the electromagnetic coil may be supplied with gradually decreasing electricity after the engaging member is moved in the first direction to a yet another position by supplying electricity to the electromagnetic coil, the elastic force of the elastic member being such that the engaging/disengaging mechanism is switched into the disengaged state when the engaging member is in yet the other position. This arrangement enables the gradual application of the repulsive force stored in the elastic member when the engaging/disengaging mechanism is switched into the disengaged state, hence restraining the engaging member from moving too rapidly in the second direction (disengaging direction).

### Advantageous Effects of the Invention

The engaging/disengaging mechanism of the present invention is capable of reducing energy consumption while the engaging/disengaging mechanism is in an engaged state.

### BRIEF DESCRIPTION OF DRAWINGS

FIG. 1 is a schematic diagram illustrating an exemplary four-wheel-drive vehicle.

FIG. 2 is a schematic diagram illustrating an exemplary four-wheel-drive vehicle.

FIG. 3 is a vertical cross-sectional view of an exemplary engaging/disengaging mechanism to which the present invention is applied.

FIG. 4 is an exploded, oblique view of a sleeve and an engaging plate constituting an engaging/disengaging mechanism.

FIG. 5 is an oblique view of the sleeve and the engaging plate constituting the engaging/disengaging mechanism when they are engaged.

FIG. 6 is a diagram representing, among other things, a positional relationship of the sleeve and the engaging plate constituting the engaging/disengaging mechanism.

FIG. 7 is a diagram representing the workings of the engaging/disengaging mechanism.

FIG. 8 is a diagram representing a relationship between electric current in an electromagnetic coil and its attractive force.

FIG. 9 is a diagram representing a relationship between the stroke of a sleeve and a spring load on a disc spring.

FIG. 10 is a timing chart illustrating an exemplary control process of electric supply to the electromagnetic coil.

FIG. 11 is a timing chart illustrating another exemplary control process of electric supply to the electromagnetic coil.

FIG. 12 is a diagram illustrating another exemplary engaging/disengaging mechanism.

FIG. 13 is a diagram illustrating a further exemplary engaging/disengaging mechanism.

### DESCRIPTION OF EMBODIMENTS

The following will describe embodiments of the present invention in reference to drawings.

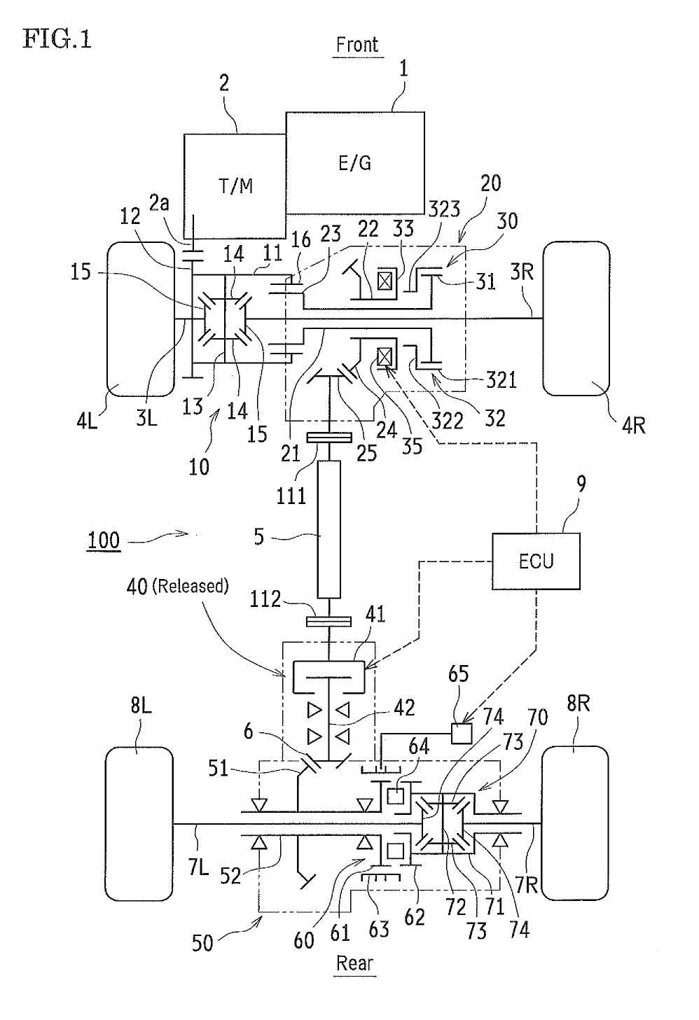

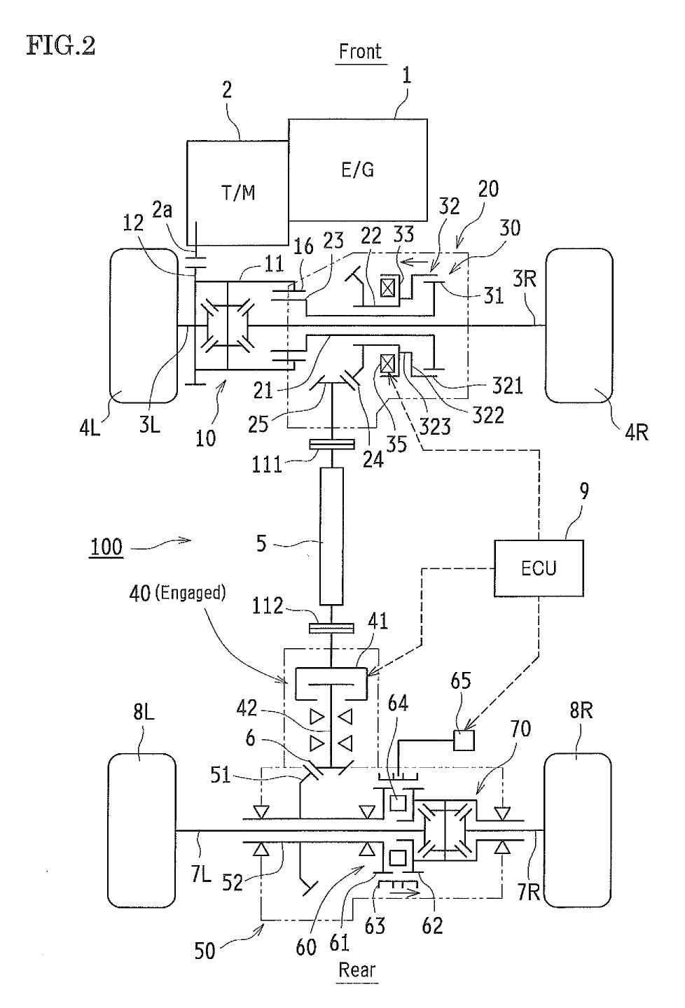

First, an exemplary vehicle to which an engaging/disengaging mechanism of the present invention is applied will be described in reference to FIGS. 1 and 2.

This exemplary vehicle is a four-wheel-drive vehicle built around an FF (front engine, front wheel drive) vehicle with a transverse engine. The vehicle includes, to name a few, an engine (E/G) 1, a transmission (T/M) 2, and a power transmission device 100. The engine (E/G) 1 is the power source for the traveling vehicle. The transmission (T/M) 2 shifts gears in relation to the rotation of the output shaft (crankshaft) of the engine 1. The power transmission device 100 is coupled to the output end of the transmission 2.

The following will describe each of these members: the engine 1, transmission 2, and power transmission device 100.

### Engine

The engine 1 is a publicly known power unit (power source) that burns hydrocarbon-based fuel, such as gasoline or diesel fuel, for power output. The engine 1 is configured to be capable of controlling operation conditions in, for example, fuel injection, ignition, and intake air regulation.

### Transmission

The transmission 2 is a stepped (planetary gear-based) automatic transmission that shifts gears by means of, for example, frictional engaging devices, such as a clutch and a brake, and a planetary gear device. The transmission 2 may be another type of transmission, such as a manual transmission or a CVT (continuously variable transmission) that adjusts the gear ratio steplessly.

The output shaft (not shown) of the transmission 2 has an output gear 2a provided thereon so that the output shaft and the output gear 2a can rotate integrally. The output gear 2a meshes with a differential driven gear 12 of a front-wheel differential device 10 (described later in detail). The power transmitted (from the engine 1) to the output shaft of the transmission 2 is transmitted to left and right front wheels (primary drive wheels) 4L and 4R via the front-wheel differential device 10 and front-wheel drive shafts 3L and 3R. In four-wheel drive state, the power transmitted to the output shaft of the transmission 2 is partly transmitted to left and right rear wheels (follower wheels) 8L and 8R via a transfer 20, a propeller shaft 5, a control clutch 40, and a rear-wheel power transmission device 50 as will be described later in detail.

### Power Transmission Device

The power transmission device 100 includes, among others, the front-wheel differential device 10, the transfer 20, the propeller shaft 5, the control clutch 40, and the rear-wheel power transmission device 50.

### Front-Wheel Differential Device

The front-wheel differential device 10 is capable of differential operation where torque is differentially distributed to the left and right front wheels 4L and 4R. The front-wheel differential device 10 includes, for example, a differential case 11, the differential driven gear 12, a pair of pinion gears 14 and 14, and a pair of side gears 15 and 15. The differential driven gear 12 is disposed on one of ends of the differential case 11 (close to the left front wheel 4L) so that the differential driven gear 12 and the differential case 11 can rotate integrally. The pinion gears 14 and 14 are supported by the differential case 11 via a pinion shaft 13 so that the pinion gears 14 and 14 are freely rotatable. The side gears 15 and 15 mesh with the pinion gears 14 and 14 and are coupled respectively to the front wheels 4L and 4R via the front-wheel drive shafts 3L and 3R. This exemplary front-wheel differential device 10 further includes a drive gear 16 disposed on the other end of the differential case 11 (the end located opposite the differential driven gear 12) so that the drive gear 16 and the differential case 11 can rotate integrally.

### Transfer

The transfer 20 includes, for example, an input shaft 21, an output shaft 22, a driven gear 23, a drive gear 24, a drive pinion gear 25, and a front-wheel engaging/disengaging mechanism 30.

The input shaft 21 is a hollow shaft disposed concentrically with the front-wheel drive shaft 3R. The output shaft 22 is a hollow shaft disposed concentrically with the input shaft 21 (front-wheel drive shaft 3R).

The input shaft 21 has an end (close to the left front wheel 4L) on which the driven gear 23 is provided so that the driven gear 23 and the input shaft 21 can rotate integrally. The driven gear 23 meshes with the drive gear 16 of the front-wheel differential device 10. The input shaft 21 can hence rotate in conjunction with the rotating differential case 11 of the front-wheel differential device 10 (in conjunction with the rotating engine 1). The output shaft 22 has an end (close to the left front wheel 4L) on which the drive gear 24 is provided so that the drive gear 24 and the output shaft 22 can rotate integrally. The drive gear 24 meshes with the drive pinion gear 25. The drive pinion gear 25 is coupled to the propeller shaft 5 via a constant velocity universal joint 111.

### Front-Wheel Engaging/Disengaging Mechanism

The front-wheel engaging/disengaging mechanism 30 is switched between an engaged state where the mechanism 30 transmits power from the input shaft 21 (engine 1 as the power source) to the output shaft 22 (propeller shaft 5) and a disengaged state where the mechanism 30 does not transmit power from the input shaft 21 to the output shaft 22. The front-wheel engaging/disengaging mechanism 30 is switched between the engaged state and the disengaged state by means of the movement of the sleeve 32. The present invention is applied to the front-wheel engaging/disengaging mechanism 30 in the present embodiment. The front-wheel engaging/disengaging mechanism 30 will be described later in detail.

### Control Clutch

The control clutch 40 is, for example, of a pilot clutch type and includes, for example, a housing 41, an output shaft 42, a main clutch, a pilot clutch (electromagnetic multi-plate clutch), a cam mechanism, an armature, and an electromagnetic coil. The housing 41 serves as an input shaft coupled to the propeller shaft 5. The output shaft 42 can rotate relative to the housing 41. The main clutch is constituted by a multi-plate frictional clutch. As the pilot clutch engages under an electromagnetic force from the electromagnetic coil, the pilot clutch transmits its engaging force to the main clutch via the cam mechanism so that the main clutch can engage (for more specific structures, see, for example, Japanese Patent Application Publications, Tokukai, Nos. 2010-254135, 2011-247306, and 2012-187954).

The housing (input shaft) 41 of the control clutch 40 is coupled to the propeller shaft 5 via a constant velocity universal joint 112. The output shaft 42 has an end (close to the rear wheels 8L and 8R) on which the drive pinion gear 6 is formed integrally.

This exemplary control clutch 40 is configured to control torque capacity, i.e., coupling torque Tc, by controlling an excitation current Ie that is supplied to the electromagnetic coil. The control clutch 40 is capable of steplessly adjusting the driving force distribution ratio, or the ratio to the total driving force of the driving force distributed to the rear wheels 8L and 8R, in a range of, for example, 0 to 0.5. The excitation current Ie supplied to the electromagnetic coil in the control clutch 40 is controlled by an ECU 9.

### Rear-Wheel Power Transmission Device

Next, will be described the rear-wheel power transmission device 50 in reference to FIGS. 1 and 2.

The rear-wheel power transmission device 50 includes, for example, a ring gear 51, a ring gear shaft 52, a rear-wheel engaging/disengaging mechanism 60, and a rear-wheel differential device 70.

The ring gear 51 is disposed on the ring gear shaft 52 so that the ring gear 51 and the ring gear shaft 52 can rotate integrally. The ring gear 51 meshes with the drive pinion gear 6 formed integrally on the output shaft 42 of the control clutch 40.

The rear-wheel differential device 70 is capable of differential operation where torque is differentially distributed to the left and right rear wheels 8L and 8R. The rear-wheel differential device 70 includes, for example, a differential case 71, a pair of pinion gears 73 and 73, and a pair of side gears 74 and 74. The pinion gears 73 and 73 are supported by the differential case 71 via a pinion shaft 72 so that the pinion gears 73 and 73 are freely rotatable. The side gears 74 and 74 mesh with the pinion gears 73 and 73 and are coupled respectively to the rear wheels 8L and 8R via rear-wheel drive shafts 7L and 7R. On an end of the differential case 71 (close to the left rear wheel 8L), this exemplary rear-wheel differential device 70 further includes a differential-end hub 62 for the rear-wheel engaging/disengaging mechanism 60 (described later in detail) so that the differential-end hub 62 and the differential case 71 can rotate integrally.

The rear-wheel engaging/disengaging mechanism 60 is disposed between the ring gear 51 and the rear-wheel differential device 70. The rear-wheel engaging/disengaging mechanism 60 is switched between an engaged state where the mechanism 60 transmits power from the ring gear 51 (ring gear shaft 52) to the rear-wheel differential device 70 and a disengaged state where the mechanism 60 does not transmit power from the ring gear 51 to the rear-wheel differential device 70.

Specifically, the rear-wheel engaging/disengaging mechanism 60 includes, for example, a ring-gear-end hub 61, the differential-end hub 62, a sleeve 63, a synchronizer mechanism 64, and an actuator 65. The ring-gear-end hub 61 is disposed on the other end of the ring gear shaft 52 (close to the right rear wheel 8R) so that the ring-gear-end hub 61 and the ring gear shaft 52 can rotate integrally. The differential-end hub 62 is disposed on one of ends of the differential case 71 of the rear-wheel differential device 70 (close to the left rear wheel 8L) so that the differential-end hub 62 and the differential case 71 can rotate integrally. The sleeve 63 switches these ring-gear-end hub 61 and differential-end hub 62 between engagement and disengagement.

The ring-gear-end hub 61 and the differential-end hub 62 are cylindrical hubs with central axes thereof lying on the rotating shaft line of the ring gear 51 (the rotating shaft line of the ring gear shaft 52). The ring-gear-end hub 61 and the differential-end hub 62 have the same diameter and are located adjacent to each other in the axial direction of the ring gear shaft 52. The ring-gear-end hub 61 and the differential-end hub 62 have formed on outer circumferential faces thereof spline external teeth that are aligned in the axial direction.

The sleeve 63 is a cylindrical member with a central axis thereof lying on the rotating shaft line of the ring gear 51 (the rotating shaft line of the ring gear shaft 52). The sleeve 63 has a larger diameter than the hubs 61 and 62. The sleeve 63 is capable of sliding in the axial direction of the ring gear shaft 52. The sleeve 63 has a spline groove formed on an inner circumferential face thereof. The spline groove can be fitted to the spline external teeth formed on the outer circumferential faces of the ring-gear-end hub 61 and the differential-end hub 62.

Actuated by the actuator 65, the sleeve 63 slides in the axial direction and moves to a position where the sleeve 63 splines only to the ring-gear-end hub 61 (“disengaged position”, shown in FIG. 1) and to a position where the sleeve 63 splines both to the ring-gear-end hub 61 and to the differential-end hub 62 (“engaged position,” shown in FIG. 2). When the sleeve 63 is in the position where the sleeve 63 splines only to the ring-gear-end hub 61, power is not transmitted from the ring gear 51 (propeller shaft 5) to the rear-wheel differential device 70 (differential case 71) (“disengaged state”). In contrast, when the sleeve 63 is in the position where the sleeve 63 splines both to the ring-gear-end hub 61 and to the differential-end hub 62, the differential case 71 rotates (around the rotating shaft line of the ring gear shaft 52) in conjunction with the rotating ring gear 51, thereby switching to a state (engaged state) where power can be transmitted from the ring gear 51 (propeller shaft 5) to the rear-wheel differential device 70. Power is hence transmitted to the left and right rear wheels 8L and 8R via the left and right rear-wheel drive shafts 7L and 7R.

While the sleeve 63 is moving from the disengaged position (shown in FIG. 1) to the engaged position (approaching the differential-end hub 62), the synchronizer mechanism 64 synchronizes the rotational speed of the sleeve 63 with the rotational speed of the differential-end hub 62. The rotational speed of the sleeve 63 is in sync with the rotational speed of the differential-end hub 62 when the sleeve 63 splines to the differential-end hub 62.

These movements of the sleeve 63 are driven by the actuator 65, and the actuator 65 is in turn controlled by the ECU 9. The actuator 65 may be, for example, an electric actuator with an electric motor as a power source, an electromagnetic actuator with a solenoid as a power source, a hydraulic actuator, or a negative pressure actuator.

### Switching Operation in Four-Wheel-Drive Vehicle

The four-wheel-drive vehicle configured as above can switch between two-wheel drive state where power is transmitted from the engine 1 only to the left and right front wheels 4L and 4R for traveling motion and four-wheel drive state where power is transmitted from the engine 1 both to the left and right front wheels 4L and 4R and to the left and right rear wheels 8L and 8R for traveling motion.

Specifically, referring to FIG. 1, to switch to two-wheel drive state, the control clutch 40 is released (non-transmitting state) to disengage both the front-wheel engaging/disengaging mechanism 30 and the rear-wheel engaging/disengaging mechanism 60 (to move the sleeve 32 and the sleeve 63 to the disengaged positions (shown in FIG. 1). The disengaged state (disengaged position) of the front-wheel engaging/disengaging mechanism 30 will be described later in detail.

In two-wheel drive state, the power transmission members (those members from the output shaft 22 of the transfer 20 to the ring-gear-end hub 61 (sleeve 63) of the ring gear shaft 52 in the rear-wheel power transmission device 50), including the propeller shaft 5, are disconnected from the rotation system including, for example, the front wheels 4L and 4R and the rear wheels 8L and 8R. That takes the inertia of the disconnected power transmission members including the propeller shaft 5 off the load on the engine 1, which allow for improvement in fuel economy (fuel consumption ratio).

The vehicle in two-wheel drive state is switched to four-wheel drive state, for example, if four-wheel-drive conditions are satisfied (e.g., if the rotational speed difference between the front and rear wheels is greater than or equal to a predetermined judgmental threshold) or if the driver manually operates a 2WD/4DW toggle switch (not shown). Specifically, the vehicle is switched from two-wheel drive state to four-wheel drive state by engaging both the front-wheel engaging/disengaging mechanism 30 and the rear-wheel engaging/disengaging mechanism 60 (moving the sleeve 32 and the sleeve 63 to the engaged positions (shown in FIG. 2)) and also supplying excitation current to the electromagnetic coil of the control clutch 40 so as to switch the control clutch 40 into the power transmitting state. The engaged state (engaged position) of the front-wheel engaging/disengaging mechanism 30 will be described later in detail.

In four-wheel drive state, the power transmitted (from the engine 1) to the output shaft of the transmission 2 is partly transmitted to the left and right rear-wheel drive shafts 7L and 7R (left and right rear wheels 8L and 8R) via the transfer 20, the propeller shaft 5, the control clutch 40, the ring gear 51, the ring gear shaft 52, the rear-wheel engaging/disengaging mechanism 60, and the rear-wheel differential device 70.

In four-wheel drive state, the transmission torque on the control clutch 40 (the power distribution ratio to the rear wheels 8L and 8R) is adjusted to maintain suitable vehicle travel stability by controlling, for example, the excitation current supply to the electromagnetic coil of the control clutch 40 in accordance with the rotational speed difference (slippage ratio) between the front and rear wheels.

The vehicle is switched from four-wheel drive state to two-wheel drive state (e.g., when the four-wheel-drive conditions are no longer satisfied or when the driver manually operates the 2WD/4DW toggle switch) by releasing the control clutch 40 (switching the control clutch 40 into the non-transmitting state) to disengage both the front-wheel engaging/disengaging mechanism 30 and the rear-wheel engaging/disengaging mechanism 60 (to move the sleeve 32 and the sleeve 63 to the disengaged positions (shown in FIG. 1)).

The switching between two-wheel drive state and four-wheel drive state, for example, by means of the control clutch 40, the front-wheel engaging/disengaging mechanism 30, and the rear-wheel engaging/disengaging mechanism 60 is controlled by the ECU 9.

### Front-Wheel Engaging/Disengaging Mechanism

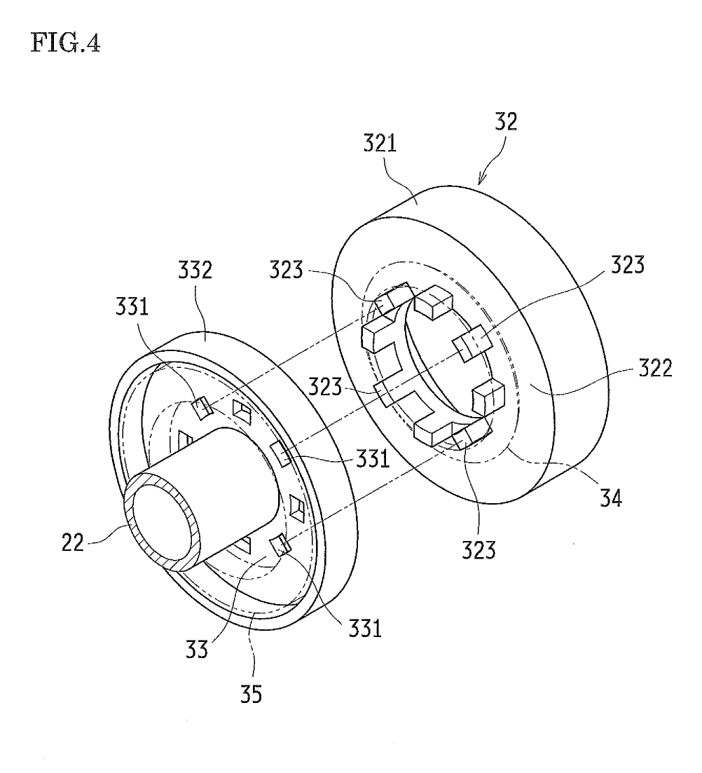

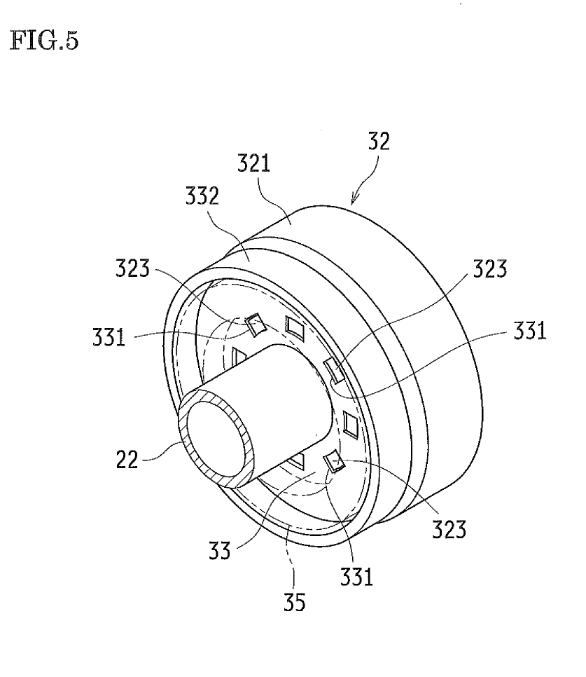

The front-wheel engaging/disengaging mechanism 30 is an exemplary embodiment of the present invention and will now be described in reference to FIGS. 1 to 10. Throughout the following description, the front-wheel engaging/disengaging mechanism 30 will be called simply the “engaging/disengaging mechanism 30”.

The engaging/disengaging mechanism 30 is an electromagnetic dog clutch and includes, for example, a clutch hub 31, an engaging plate 33, the sleeve 32, a disc spring (elastic member) 34, and an electromagnetic coil 35. The sleeve 32 switches these clutch hub 31 and engaging plate 33 between engagement and disengagement. The clutch hub 31 is disposed at the other end of the input shaft 21 of the transfer 20 (close to the right front wheel 4R) so that the clutch hub 31 and the input shaft 21 can rotate integrally. The engaging plate 33 is disposed at the other end of the output shaft 22 of the transfer 20 (close to the right front wheel 4R) so that the engaging plate 33 and the output shaft 22 can rotate integrally.

The clutch hub 31 is a hub with a central axis thereof lying on the rotating shaft line of the input shaft 21. The clutch hub 31 has formed on an outer circumferential face thereof spline external teeth 31a that are aligned in the axial direction of the input shaft 21 and the output shaft 22. The clutch hub 31 and the engaging plate 33 are separated by a predetermined distance in the axial direction.

The sleeve 32 is a member that is integrally constituted by a spline engaging section 321, an armature 322, and eight dog teeth 323.

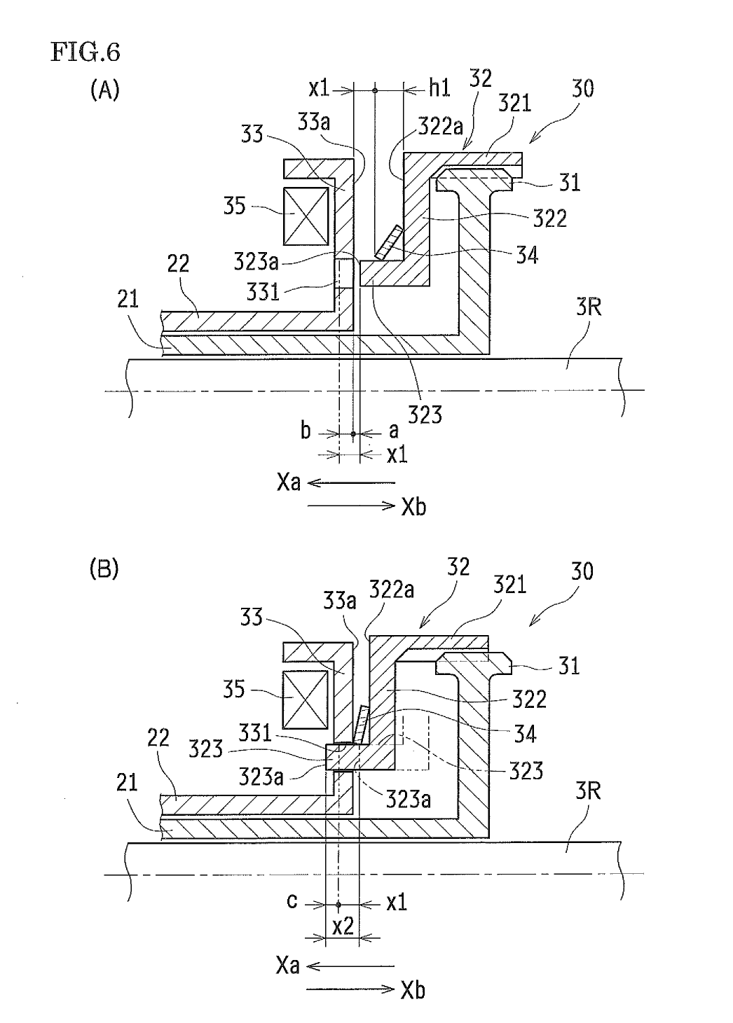

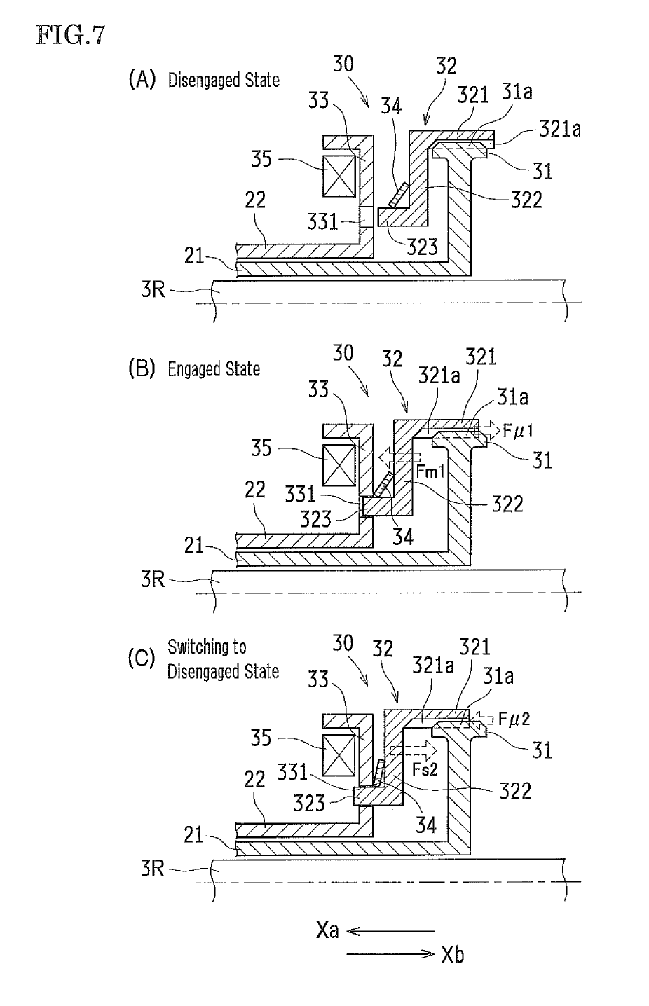

The spline engaging section 321 is a cylindrical member (having a larger diameter than the clutch hub 31) with a central axis thereof lying on the rotating shaft line of the input shaft 21 and the output shaft 22. The spline engaging section 321 has formed on an inner circumferential face thereof spline internal teeth 321a that are aligned in the axial direction. The spline internal teeth 321a on the spline engaging section 321 spline to the spline external teeth 31a formed on the outer circumferential face of the clutch hub 31. This spline connection enables the sleeve 32 to rotate integrally with the clutch hub 31. The spline connection also enables the sleeve 32 to slide relative to the clutch hub 31 in the axial direction of the input shaft 21 and the output shaft 22. Accordingly, the sleeve 32 can move in direction Xa (approaching the engaging plate 33) and in direction Xb (away from the engaging plate 33). Even when the sleeve 32 is moved in direction Xa reaching a motion-ending point described later in detail (the position represented in FIGS. 6(B) and 7(C)), the spline connection is maintained. Direction Xa corresponds to the “first direction” in the present invention, and direction Xb corresponds to the “second direction” in the present invention.

The armature 322 is a member shaped like a circular ring. The armature 322 is dispose on an end of the spline engaging section 321 (close to the left front wheel 4L (engaging plate 33)). The dog teeth 323 are members with a uniform cross-section that project from the armature 322 in direction Xa (approaching the engaging plate 33) parallel to the axial direction of the input shaft 21 and the output shaft 22. The eight dog teeth 323 are disposed on a circle around the rotating shaft line of the sleeve 32 (the rotating shaft line of the input shaft 21) so that they are rotationally symmetric. The eight dog teeth 323 have the same cross-sectional shape (when they are cut up by a plane normal to the axial direction).

The number of dog teeth 323 is not limited to eight. Any other number of dog teeth 323 may be provided on the sleeve 32. The same applies to engaging holes 331 (described later in detail) in the engaging plate 33.

The engaging plate 33 is a member shaped like a circular ring with a central axis thereof lying on the rotating shaft line of the input shaft 21 and the output shaft 22. The engaging plate 33 has a flange 332 formed integrally on an outer periphery thereof. The flange 332 projects from the outer periphery of the engaging plate 33 in direction Xa (approaching the left front wheel 4L). The electromagnetic coil 35 is disposed between the flange 332 and the output shaft 22. The electromagnetic coil 35 is supported by the engaging plate 33. The electromagnetic coil 35 and the armature 322 of the sleeve 32 constitute the “actuation mechanism” of the present invention. The armature 322 (sleeve 32) is magnetically attracted in direction Xa by the electromagnetic force (attractive force) generated by the electricity supplied to the electromagnetic coil 35. The amount of electric supply to the electromagnetic coil 35 will be described later in detail. The supply of electricity to the electromagnetic coil 35 is controlled by the ECU 9.

The engaging plate 33 has engaging holes (through holes) 331 at locations that respectively correspond to the dog teeth 323 on the sleeve 32. The engaging holes 331 have a shape that corresponds to the cross-sectional shape of the dog teeth 323. The engaging holes 331 have a larger size than the dog teeth 323 by a predetermined amount so that the dog teeth 323 can engage (fit into) the engaging holes 331. The engaging holes 331 and the dog teeth 323 constitute a dog clutch section.

The armature 322, formed integrally to the sleeve 32, is located between the clutch hub 31 and the engaging plate 33 so that the armature 322 faces the engaging plate 33. The disc spring 34 is located between the armature 322 and the engaging plate 33 so that the inner circumferential portion of the disc spring 34 that is on one of two sides of the disc spring 34 on which its diameter is smaller than on the other side is in contact with the outer circumferential face of the dog teeth 323.

### Positional Relationship

Next will be described the positional relationship between the sleeve 32 and the engaging plate 33, both constituting the engaging/disengaging mechanism 30. The stroke of the sleeve 32 will also be described.

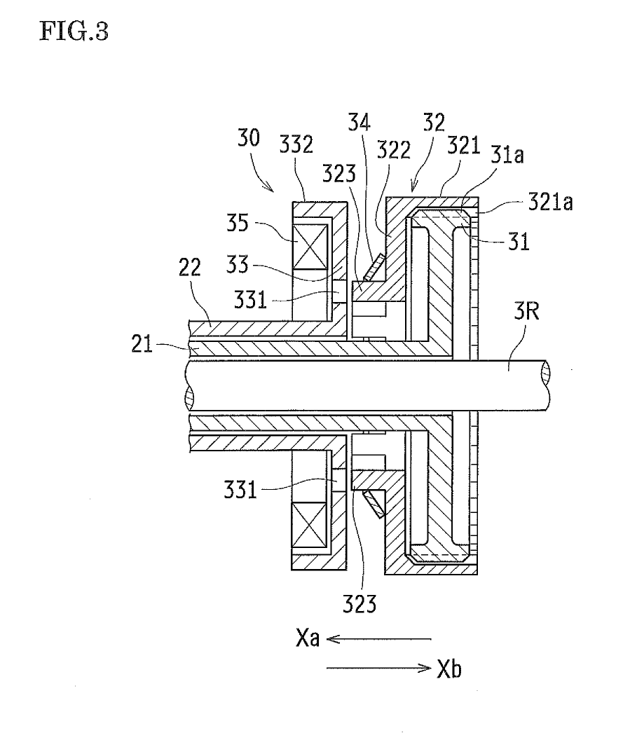

First, as illustrated in FIGS. 3, 6(A), and 7(A), when the sleeve 32 is at the motion-ending point in direction Xb (when the armature 322 is positioned farthest from the engaging plate 33), a side face 322a of the armature 322 (that faces the engaging plate 33) is separated from a side face 33a of the engaging plate 33 (that faces the armature 322) by a distance that is equal to Engaging Stroke x1+Height h1 of Disc Spring 34. When the sleeve 32 is located in this position (the motion-ending point in direction Xb), there exists a gap “a” between tip end faces 323a of the dog teeth 323 on the sleeve 32 and the side face 33a of the engaging plate 33, so that the dog teeth 323 on the sleeve 32 do not engage the engaging holes 331 in the engaging plate 33, that is, the engaging/disengaging mechanism 30 is in the disengaged state.

When the sleeve 32, starting from the position represented in FIGS. 3, 6(A), and 7(A) (disengaged position), is moved in direction Xa by as much as engaging stroke x1 by the attractive force Fm1 (detailed later) generated by the electromagnetic coil 35, the dog teeth 323 on the sleeve 32 engage (fit into) the engaging holes 331 in the engaging plate 33, which switches the engaging/disengaging mechanism 30 into the engaged state (as shown in FIG. 7(B)). In the engaged state, the dog teeth 323 are inserted into the engaging holes 331 by the amount of “b”, and Engaging Stroke x1=a+b.

The motion-ending point in direction Xa for the sleeve 32 is the position, represented in FIGS. 6(B) and 7(C), that the sleeve 32 reaches when it is moved by stroke x2 (disengaging stroke x2) in direction Xa from the position represented in FIGS. 6(A) and 7(A). As the sleeve 32 reaches this position (motion-ending point in direction Xa) (the movement is driven by the attractive force Fm2 generated by the electromagnetic coil 35, which will be detailed later), the disc spring 34 warps (elastic deformation). The disc spring 34 stores elastic force that switches the engaging/disengaging mechanism 30 into the disengaged state, i.e., elastic force capable of moving the sleeve 32 (engaging member) in direction Xb (second direction) to switch the engaging/disengaging mechanism 30 into the disengaged state. Note that Disengaging Stroke x2=x1+c (warpage of the disc spring 34)=a+b+C.

The warpage (compression) “c” of the disc spring 34 is determined, for example, through experiments and simulations by considering the modulus of elasticity of the disc spring 34 and other factors. The warpage of the disc spring 34 generates elastic force (spring load Fs2) that switches the engaging/disengaging mechanism 30 into the disengaged state.

### Switching of Engaging/Disengaging Mechanism

Next will be described the switching of the engaging/disengaging mechanism 30 in reference to, especially, FIGS. 3, 6, and 7.

First, when the engaging/disengaging mechanism 30 is in the disengaged state, no electric current flows in the electromagnetic coil 35 (the coil 35 is not magnetically excited); the sleeve 32 is in the position represented in FIGS. 6(A) and 7(A), i.e., in the motion-ending point in direction Xb; and the dog teeth 323 on the sleeve 32 do not engage the engaging holes 331 in the engaging plate 33.

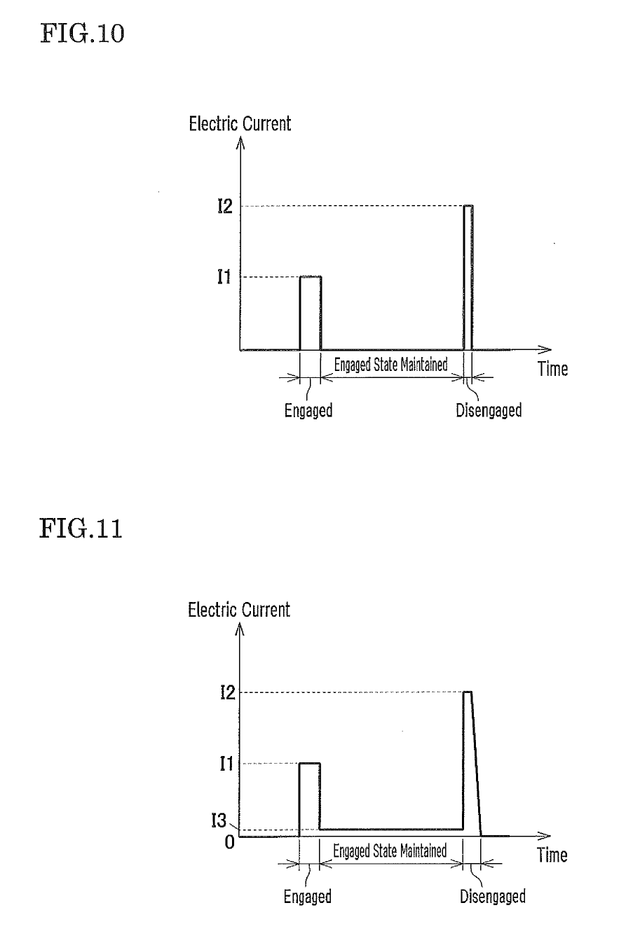

Next, to switch the engaging/disengaging mechanism 30 into the engaged state, electricity, or electric current (=I1), is supplied to the electromagnetic coil 35 (see FIG. 10).

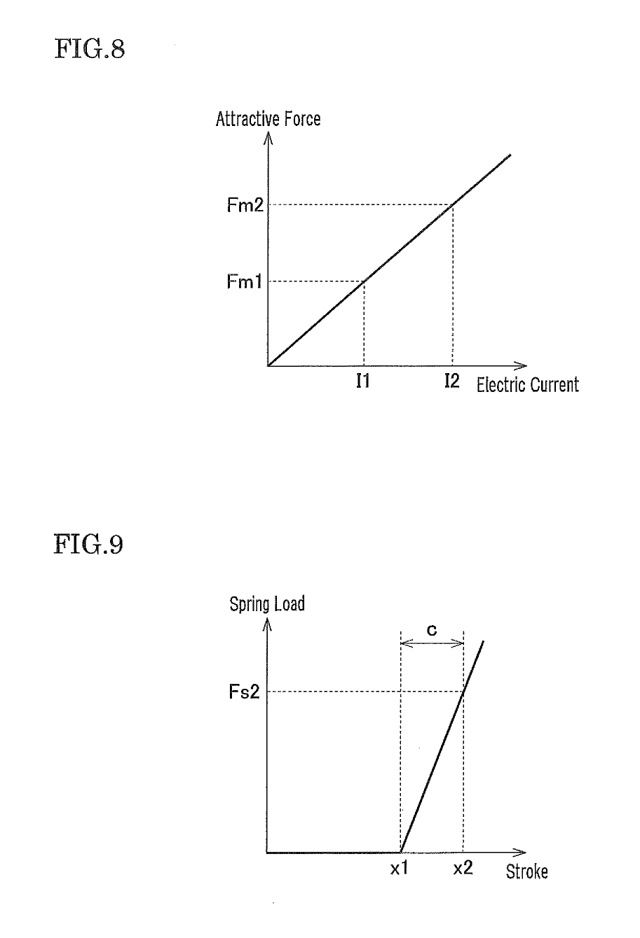

This electric current I1 has such a value as to excite the electromagnetic coil 35 to generate attractive (electromagnetic) force Fm1 (>Fμ1) that is sufficiently intense to magnetically attract the armature 322 (see FIG. 8), but less intense than the force that warps the disc spring 34 when the disc spring 34 is interposed between the side face 322a of the armature 322 and the side face 33a of the engaging plate 33 as a result of the sleeve 32 being moved by magnetic attraction in direction Xa (approaching the engaging plate 33) (elastic force less intense than the force that switches the engaging/disengaging mechanism into the disengaged state). Fμ1 is resistance from the spline engaging section and other parts of the sleeve 32 (see FIG. 7(B)).

As this particular electric current I1 is supplied to the electromagnetic coil 35 (as the electric current I1 flows in the electromagnetic coil 35), the sleeve 32 in the disengaged position moves in direction Xa (approaching the engaging plate 33), and during the course of the movement, the dog teeth 323 on the sleeve 32 fit into the engaging holes 331 in the engaging plate 33. When the sleeve 32 is moved by engaging stroke x1 in direction Xa, the front end (where the disc spring 34 has a smaller diameter) and the rear end (where the disc spring 34 has a larger diameter) of the non-deformed disc spring 34 strike the side face 33a of the engaging plate 33 and the side face 322a of the armature 322 respectively. That regulates the position of the sleeve 32 in the axial direction. The engaging/disengaging mechanism 30 is now in the engaged state (see FIG. 7(B). In this engaged state (when the sleeve 32 is moved by engaging stroke x1 in direction Xa), the disc spring 34 is not warped, and its spring load is 0 (see FIG. 9). The duration of electric supply to the electromagnetic coil 35 in the switching to the engaged state is appropriately set to a value that, determined, for example, through experiments and simulations in advance, allows the dog teeth 323 to completely fit into the engaging holes 331.

The sleeve 32 and the engaging plate 33 may have different rotational speeds when the engaging/disengaging mechanism 30 is to be switched into the engaged state. The dog teeth 323 on the sleeve 32 are pressed against the side face 33a of the engaging plate 33 by the attractive force from the electromagnetic coil 35. The dog teeth 323 slide on the side face 33a due to the rotational speed difference between the sleeve 32 and the engaging plate 33 until the dog teeth 323 fit into the engaging holes 331, when the difference is eliminated and the engaging/disengaging mechanism 30 is switched into the engaged state.

After completing the switching to the engaged state, the electric supply to the electromagnetic coil 35 is stopped (zero electric current in the electromagnetic coil 35). Likewise, no electricity is supplied to the electromagnetic coil 35 while the engaging/disengaging mechanism 30 is in the engaged state (see FIG. 10). The engaged state of the engaging/disengaging mechanism 30 shown in FIG. 7(B) can be maintained with no electricity being supply to the electromagnetic coil 35 because the disc spring 34 is not warped and the spring load (repulsive force from the disc spring 34) is substantially 0.

Next will be described the switching of the engaging/disengaging mechanism 30 from the engaged state shown in FIG. 7(B) into the disengaged state.

To switch the engaging/disengaging mechanism 30 into the disengaged state, electricity, or electric current (=I2), is supplied to the electromagnetic coil 35 (see FIG. 10).

This electric current I2 has such a value as to excite the electromagnetic coil 35 to generate attractive (electromagnetic) force Fm2 (=Fs2) that is sufficiently intense to magnetically attract the armature 322 (see FIG. 8), or in other words, sufficiently intense to move the sleeve 32 against the elastic force (repulsive force) of the disc spring 34 in direction Xa from the position shown in FIGS. 6(A) and 7(A) to the position where disengaging stroke x2 (x2=x1+c) is reached (i.e., where the warpage “c” of the disc spring 34 is reached).

When the warpage of the disc spring 34 equals to “c”, the spring load Fs2 on the disc spring 34 (i.e., the elastic force of the disc spring 34) is larger than the resistance Fμ2 from the spline engaging section and other parts of the sleeve 32 (see FIG. 7(C)) (Fs2>Fμ2). In other words, the spring load Fs2 is an elastic force capable of moving the sleeve 32 (engaging member) in direction Xb (second direction) from the position shown in FIG. 7(C) to switch the engaging/disengaging mechanism 30 into the disengaged state. The resistance Fμ2 includes, for example, the engagement resistance between the dog teeth 323 and the engaging holes 331.

As illustrated in FIG. 9, the spring load on the disc spring 34 starts to occur when the stroke of the sleeve 32 exceeds x1 and reaches Fs2 when the stroke of the sleeve 32 reaches x2.

After that, as the particular electric current I2 is supplied to the electromagnetic coil 35 (as the electric current I2 flows in the electromagnetic coil 35), the sleeve 32 moves to the position of disengaging stroke x2, and as illustrated in FIG. 7(C), the warped disc spring 34 (warpage=c) is interposed between the armature 322 (side face 322a) of the sleeve 32 and the engaging plate 33 (side face 33a). When the electric supply to the electromagnetic coil 35 is stopped in this state (zero electric current in the electromagnetic coil 35), the entire sleeve 32 moves in direction Xb due to the elastic force (repulsive force=Fs2) of the disc spring 34 (the sleeve 32 is thrown off in direction Xb by the repulsive force of the disc spring 34). During the course of the movement of the sleeve 32 in direction Xb, the dog teeth 323 on the sleeve 32 come out of the engaging holes 331 in the engaging plate 33, after which the sleeve 32 returns to the position shown in FIGS. 6(A) and 7(A) (disengaged position, or motion-ending point in direction Xa), thereby switching the engaging/disengaging mechanism 30 into the disengaged state.

The switching of the engaging/disengaging mechanism 30, i.e., the electric supply to the electromagnetic coil 35 represented in FIG. 10 is controlled (2-stage electric current control) by the ECU (control section) 9.

### Effects

As described so far, according to the present embodiment, the engaging/disengaging mechanism 30 is switched into the engaged state by moving the sleeve 32 to the position where the disc spring 34 does not warp (the position of stroke x1). There is no need to overcome the repulsive force of the disc spring 34 in switching the engaging/disengaging mechanism 30 into the engaged state. That allows for reduction in the electric supply to the electromagnetic coil 35, which in turn allows for reduction in electric power consumption. Besides, the engaging/disengaging mechanism 30 can be maintained in the engaged state even if the electric supply to the electromagnetic coil 35 is stopped. That allows for reduction in electric power consumption and heat generation by the electromagnetic coil 35.

The engaging/disengaging mechanism 30 is switched into the disengaged state by moving the sleeve 32 to the position where sufficient elastic force is generated that enables disengagement of the engaging/disengaging mechanism 30 (to the position where the warpage of the disc spring 34 reaches “c”) and thereafter stopping the electric supply to the electromagnetic coil 35 so that the sleeve 32 can be moved in direction Xb (disengaging direction) by the repulsive force of the disc spring 34. That also allows for reduction in electric power consumption when the engaging/disengaging mechanism 30 is disengaged.

The engaging/disengaging mechanism 30 of the present embodiment, including the electromagnetic coil 35, allows for more reduction in size than the engaging/disengaging mechanism including the actuator 65 and other relevant members shown in FIG. 1. This is a large advantage to FF vehicles with a transverse engine. The size reduction of the engaging/disengaging mechanism is a large advantage to the transverse-engine FF vehicle that has little space for the installation of components near the front wheels.

### Variation Examples of Control of Electric Supply

In the embodiment above, the electric supply to the electromagnetic coil 35 is stopped (zero electric current in the electromagnetic coil 35) after switching the engaging/disengaging mechanism 30 into the engaged state.

The present invention is by no means limited to this arrangement. Alternatively, as an example, as illustrated in FIG. 11, after switching the engaging/disengaging mechanism 30 into the engaged state, the electric supply to the electromagnetic coil 35 may be equal to I3 (I3<I1<I2) so that the electric current I3 can be supplied to the electromagnetic coil 35 while the engaging/disengaging mechanism 30 is maintained in the engaged state.

This electric current I3 has such a value as to reliably maintain the engaging/disengaging mechanism 30 in the engaged state and is appropriately set to such an electric power (electric current) value, determined, for example, through experiments and simulations, as to prevent the dog teeth 323 from coming out of the fitting in the engaging holes 331 even if the engaging/disengaging mechanism 30 is subject to vehicle vibration or other forms of disturbance.

While the electric current I3 is being supplied to the electromagnetic coil 35 to maintain the engaged state in this manner, the sleeve 32 is being pulled toward the engaging plate 33. Therefore, even if the engaging/disengaging mechanism 30 is subject to vibration and another disturbances, the dog teeth 323 do not come out of the engaging holes 331. That maintains the engaged state of the engaging/disengaging mechanism 30 more reliably.

The electric current (electric supply) 13 has such a value as to reliably maintain the engaged state and is preferably as small (low) as possible.

In the embodiments above, the engaging/disengaging mechanism 30 is disengaged by moving the sleeve 32 to the position where the elastic force of the disc spring 34 is sufficient (equal to the spring load Fs2) to switch the engaging/disengaging mechanism 30 into the disengaged state (the position of stroke x2). After that, the electric supply to the electromagnetic coil 35 is stopped (zero electric current in the electromagnetic coil 35). The present invention is by no means limited to this arrangement. Alternatively, as an example, as illustrated in FIG. 11, the electric supply to the electromagnetic coil 35 may be gradually decreased in disengaging the engaging/disengaging mechanism 30. This arrangement restrains the sleeve 32 from moving too rapidly in direction Xb (disengaging direction), which will be described next in detail.

If the electric supply to the electromagnetic coil 35 is stopped (zero magnetically attractive force) after moving the sleeve 32 to the position of stroke x2 to disengage the engaging/disengaging mechanism 30, the repulsive force (spring load Fs2) stored in the disc spring 34 is applied suddenly to the sleeve 32. The repulsive force could too rapidly throw the sleeve 32 off in direction Xb. In this situation, the sleeve 32 could collide with the clutch hub 31, generating abnormal sound. In contrast, if the electric supply to the electromagnetic coil 35 is gradually decreased in disengaging the engaging/disengaging mechanism 30, the repulsive force stored in the disc spring 34 is gradually applied to the sleeve 32: This arrangement restrains the sleeve 32 from moving too rapidly in direction Xb (disengaging direction), reducing the generation of the abnormal sound.

### Other Embodiments

The embodiments disclosed here are for illustrative purposes only in every respect and do not constitute support for restrictive interpretations. The scope of the present invention is defined only by the claims and never bound by the embodiments only. Those modifications and variations that may lead to equivalents of claimed elements are all included within the scope of the invention.

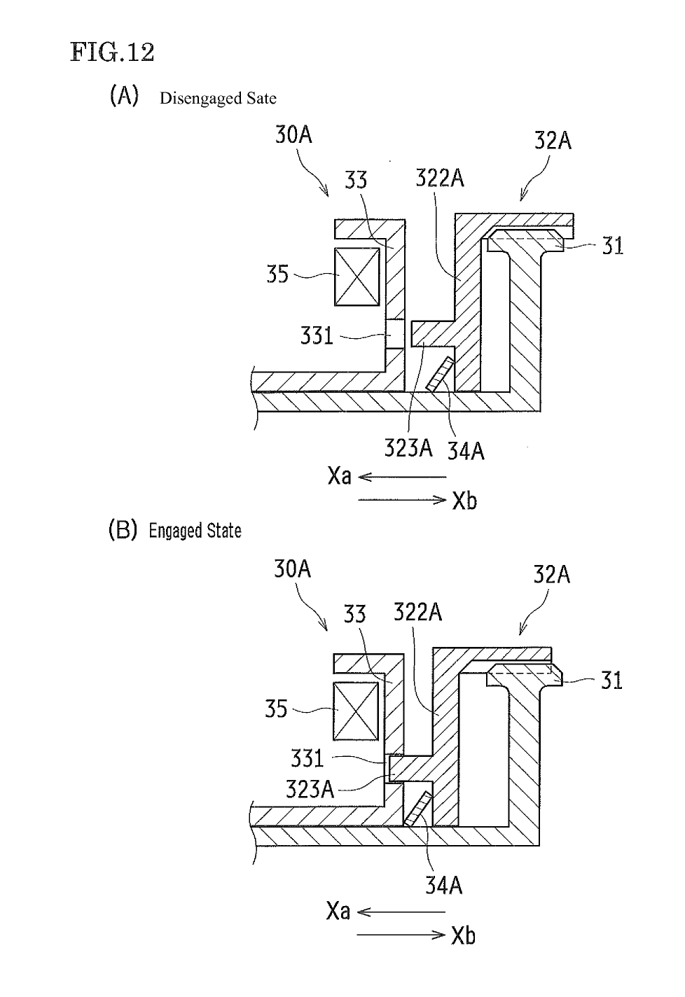

For example, in the embodiments-above, the disc spring 34 is located closer to the outer periphery than are the dog teeth 323 on the sleeve 32. The present invention is by no means limited to this arrangement. Alternatively, as an example, as illustrated in FIG. 12, a disc spring 34A may be provided closer to the center than dog teeth 323A formed integrally to an armature 322A of a sleeve 32A.

Referring to FIG. 12, the electric current I1 may be also supplied to the electromagnetic coil 35 when an engaging/disengaging mechanism 30A arranged as shown in FIG. 12 is in the disengaged state shown in FIG. 12(A), so as to move the sleeve 32A in direction Xa and during the course of the movement, fit the dog teeth 323A on the sleeve 32A into the engaging holes 331 in the engaging plate 33, which in turn switches the engaging/disengaging mechanism 30A into the engaged state (FIG. 12(B)).

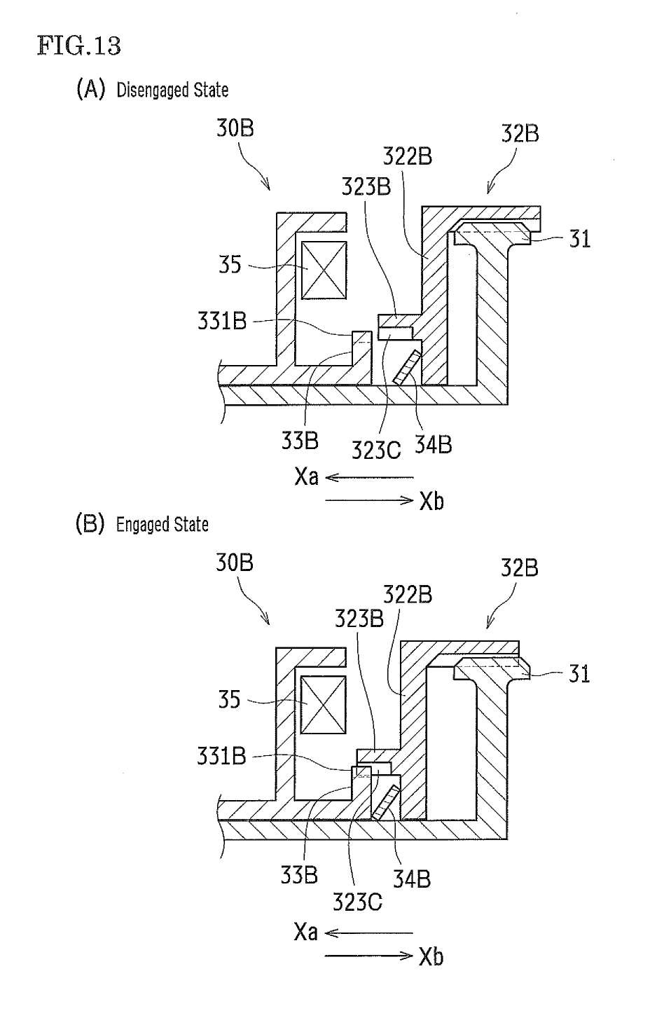

The embodiments above have described the exemplary applications of the present invention to the engaging/disengaging mechanism that includes a dog clutch section constituted by dog teeth and engaging holes. The present invention is by no means limited to this arrangements. An exemplary engaging/disengaging mechanism arranged in a different manner will be described in reference to FIG. 13.

In the example shown in FIG. 13, a cylindrical boss section 323B is formed integrally to an armature 322B of a sleeve 32B, and spline internal teeth 323C are formed on an inner circumferential face of the boss section 323B. Spline external teeth 331B are formed on an outer circumferential face of an engaging plate 33B that is shaped like a circular disc. The spline external teeth 331B mesh with the spline internal teeth 323C on the inner circumferential face of the boss section 323B.

In this example shown in FIG. 13, the electric current I1 is supplied to the electromagnetic coil 35 when an engaging/disengaging mechanism 30B is in the state shown in FIG. 13(A), so as to move the sleeve 32B in direction Xa and during the course of the movement, spline-connect the spline internal teeth 323C on the sleeve 32B to the spline external teeth 331B on the engaging plate 33B, which switches the engaging/disengaging mechanism 30B into the engaged state (FIG. 13(B)). A disc spring 34B in this example shown in FIG. 13 is provided between the armature 322B and the engaging plate 33B, closer to the outer periphery than is the boss section 323B.

The clutch section provided in the engaging/disengaging mechanism may have a different structure from those described above. For example, the clutch section may be structured so that the dog teeth provided close to the input shaft can mesh with the dog teeth provided close to the output shaft or structured to include a frictional clutch plate. Alternatively, the clutch section may be structured to include a clutch section in which the armature by itself constitutes an input- or output-end engaging member.

In the embodiments above, the elastic member storing elastic force that moves the engaging member (sleeve) in the second direction (disengaging direction) to switch the engaging/disengaging mechanism into the disengaged state is a disc spring. The present invention is by no means limited to this arrangement. Alternatively, as examples, a coil spring or any other elastic member may be used.

In the embodiments above, the actuation mechanism that moves the engaging member (sleeve) is an actuation mechanism constituted by an electromagnetic coil and an armature. The present invention is by no means limited to this arrangement. Alternatively, as examples, a hydraulic actuation mechanism or a negative pressure (pneumatic) actuation mechanism may be used.

The embodiments above have described the exemplary applications of the present invention to the front-wheel engaging/disengaging mechanism. The present invention is by no means limited to this arrangement. Alternatively, the present invention may be applied to a rear-wheel engaging/disengaging mechanism. The present invention may be applied to both a front-wheel engaging/disengaging mechanism and a rear-wheel engaging/disengaging mechanism. The present invention may also be applied to an engaging/disengaging mechanism provided for a different power transmission system of the vehicle.

The embodiments above have described the applications of the present invention to the engaging/disengaging mechanism provided in four-wheel-drive FF vehicles. The present invention is by no means limited to this arrangement. Alternatively, the present invention is also applicable to an engaging/disengaging mechanism provided in four-wheel-drive FR (front engine, rear wheel drive) vehicles. The present invention is also applicable to an engaging/disengaging mechanism provided in two-wheel-drive FF and FR vehicles.

The embodiments above have described the applications of the present invention to a display device provided in vehicles that include gasoline engines, diesel engines, or other like engines as power sources. The present invention is by no means limited to this arrangement. Alternatively, the present invention is applicable to an engaging/disengaging mechanism provided in hybrid vehicles that include an engine and an electric motor (e.g., a motor generator) as power sources.

The present invention is by no means limited to applications to an engaging/disengaging mechanism that is provided in vehicles. Alternatively, the present invention is applicable to an engaging/disengaging mechanism used in power transmission systems of other various types of apparatus and devices.

### INDUSTRIAL APPLICABILITY

The present invention may be effectively applied to an engaging/disengaging mechanism in vehicles and other power transmission systems that switches between an engaged state where power is transmitted and a disengaged state where power is not transmitted.

### REFERENCE SIGNS LIST

30 Front-wheel Engaging/disengaging Mechanism (Engaging/disengaging Mechanism)
31 Clutch Hub
31a Spline External Teeth
32 Sleeve (Engaging Member)
321 Spline Engaging Section
321a Spline Internal Teeth
322 Armature
322a Side Face of Armature
323 Dog Teeth
33 Engaging Plate
33a Side Face of Engaging Plate
331 Engaging Hole
34 Disc Spring
35 Electromagnetic Coil

1. An engaging/disengaging mechanism that enables/disables power transmission, comprising:
an actuation mechanism capable of transmitting power to an engaging member in order to move the engaging member in a first direction to switch the engaging/disengaging mechanism into an engaged state and in a second direction to switch the engaging/disengaging mechanism into a disengaged state; and
an elastic member capable, as a result of the engaging member being moved in the first direction, of storing such elastic force that the engaging member is moved in the second direction to switch the engaging/disengaging mechanism into the disengaged state,
wherein to switch the engaging/disengaging mechanism into the engaged state, the power transmitted by the actuation mechanism to the engaging member is reduced after the engaging member is moved in the first direction to a position by the power transmitted by the actuation mechanism to the engaging member so that the engaging/disengaging mechanism is switched into the engaged state, the elastic force of the elastic member being less intense when the engaging member is in the position than when the engaging/disengaging mechanism is switched into the disengaged state.

2. The engaging/disengaging mechanism as set forth in claim 1, wherein
to switch the engaging/disengaging mechanism into the disengaged state, the power transmitted by the actuation mechanism is reduced after the engaging member is moved in the first direction to another position by the power transmitted by the actuation mechanism to the engaging member, the elastic force of the elastic member being such that the engaging/disengaging mechanism is switched into the disengaged state when the engaging member is in the other position.

3. The engaging/disengaging mechanism as set forth in claim 1, wherein:
the actuation mechanism includes: an armature provided integrally to the engaging member; and an electromagnetic coil; and
the actuation mechanism magnetically attracts the armature by supplying electricity to the electromagnetic coil in order to move the engaging member in the first direction.

4. The engaging/disengaging mechanism as set forth in claim 3, wherein
to switch the engaging/disengaging mechanism into the engaged state or to maintain the engaging/disengaging mechanism in the engaged state, the electromagnetic coil is supplied with less electricity than to switch the engaging/disengaging mechanism into the disengaged state.

5. The engaging/disengaging mechanism as set forth in claim 3, wherein to maintain the engaging/disengaging mechanism in the engaged state, the electromagnetic coil is stopped from being supplied with electricity.

6. The engaging/disengaging mechanism as set forth in claim 3, wherein to maintain the engaging/disengaging mechanism in the engaged state, the electromagnetic coil is supplied with electricity that is less than to switch the engaging/disengaging mechanism into the engaged state, but sufficient to maintain the engaging/disengaging mechanism in the engaged state.

7. The engaging/disengaging mechanism as set forth in claim 3, wherein to switch the engaging/disengaging mechanism into the disengaged state, the electromagnetic coil is stopped from being supplied with electricity after the engaging member is moved in the first direction to a further position by supplying electricity to the electromagnetic coil, the elastic force of the elastic member being such that the engaging/disengaging mechanism is switched into the disengaged state when the engaging member is in the further position.

8. The engaging/disengaging mechanism as set forth in claim 3, wherein to switch the engaging/disengaging mechanism into the disengaged state, the electromagnetic coil is supplied with gradually decreasing electricity after the engaging member is moved in the first direction to a yet another position by supplying electricity to the electromagnetic coil, the elastic force of the elastic member being such that the engaging/disengaging mechanism is switched into the disengaged state when the engaging member is in yet the other position.
